(19) United States
(12) Patent Application Publication
(10) Pub. No.: US 2004/0195970 A1
(43) Pub. Date: Oct. 7, 2004

(54) Cold cathode fluorescent flat lamp

(76) Inventors: Shih-Hsien Lin, Hsinchu Hsien (TW); Kuang-Lung Tsai, Hsinchu (TW); Cheng-Yi Chang, Hsinchu City (TW); Hsu Ming-Fu, Kaohsiung (TW); Yui-Shin Fran, Hsinchu (TW); Ruey-Feng Jean, Tainan (TW)

Correspondence Address: J.C. Patents, Inc., 4 Venture, Suite 250, Irvine, CA, 92618, US

(21) Appl. No.: 10/812,447

(22) Filed: Mar. 29, 2004

(30) Foreign Application Priority Data
Apr. 2, 2003 (TW) 92107487

(51) Int. Cl. H01J 1/62; H01J 63/04

(52) U.S. Cl. 313/634; 313/637

(57) ABSTRACT

A cold cathode fluorescent flat lamp comprising a first plate, a second plate, a fluorescent substance, a discharge gas and a plurality of electrodes is provided. The first plate has a plurality of grooves. The second plate is disposed on the first plate on which the grooves form airtight chambers. The fluorescent substance is disposed on the inner wall of the airtight chambers; the discharge gas is disposed in the airtight chambers; and the electrodes are disposed on both sides of various airtight chambers. Therefore, by disposing the grooves on the inner surface of the first plate, the second plate can dispose on the first plate directly. Furthermore, the second plate disposing on the first plate directly can enhance the strength of the cold cathode fluorescent flat lamp without using rods and spacers.

### CROSS-REFERENCE TO RELATED APPLICATION

This application claims the priority benefit of Taiwan application serial no. 92107487, filed on Apr. 2, 2003.

### BACKGROUND OF THE INVENTION

1. Field of Invention

The present invention generally relates to a cold cathode fluorescent flat lamp (CCFFL), and more particularly, to a cold cathode fluorescent flat lamp having high structure strength and capable of providing an even-distributed plane light source.

2. Description of Related Art

Digital tools such as the mobile phone, digital camera, digital video camcoder, notebook computer, and desktop computer, all developed along a trend of convenience, versatility, and more beautiful appearence. However, the display used in the mobile phone, digital camera, digital video cam-coder, notebook computer, and desktop computer is inevitably a human-machine communication interface, and through the display of the products mentioned above, user operation is made more convenient. Recently, the LCD panel has been used as mainstream for the display of most mobile phones, digital cameras, digital video cam-coders, notebook computers, and desktop computers. However, since the LCD panel lacks the function of emitting light itself; a backlight module has to be configured under the LCD panel to provide a light source, and so achieve the object of display.

A commonly seen backlight module in the prior art mainly comprises a lamp, a holder, and a light guiding plate (LGP). The light guiding plate mentioned above is able to convert a linear light emitted by the lamp into a type of plane light source. Since the lamp is usually disposed on one side of the light guiding plate, the plane light source provided by the light guiding plate is not evenly distributed. Therefore, several optical plates (e.g. diffusion plates, light enhancement plates, etc.) have to be disposed on a light emitting surface of the light guiding plate. However, since the light guiding plate and the optical plate are not cheap, cost of the backlight module is increased. Further, since each of the lamp, the holder, and the light guiding plate is an independent component, a frame has to be configured for holding and fixing the lamp, holder, and light guiding plate mentioned above. From the description above, it is known that such type of backlight module is complicated in its assembly and its assembly cost cannot be further reduced.

Based on the above considerations, a conventional cold cathode fluorescent flat lamp is developed. Since the cold cathode fluorescent flat lamp is characterized by its better lighting efficiency and even distribution and is able to provide a big size plane light source, the cold cathode fluorescent flat lamp has been widely applied as the backlight source of the LCD panel, and in other fields of application.

The cold cathode fluorescent flat lamp is a kind of plasma lighting element. After electrons are ejected from the cathode, the electrons collide with the inert gas between the cathode and the anode in the airtight chamber, and the gas is ionized and excited to form a plasma. Then, the excited atoms excited by the plasma return to a steady state by emitting in ultraviolet, and the emitted ultraviolet emissions then excite the fluorescent substance inside the cold cathode fluorescent flat lamp to generate visible light.

FIG. 1 schematically shows a vertical view of a conventional cold cathode fluorescent flat lamp. FIG. 2 schematically shows a sectional view seen from the cross-sectional line A-A in FIG. 1. Referring to both FIG. 1 and FIG. 2, the conventional cold cathode fluorescent flat lamp mainly comprises a plate 110, a plate 120, a plurality of edge strips 130, a fluorescent substance 140, a discharge gas 150, and a plurality of electrodes 160. Wherein, the plate 110 and the plate 120 are made of a material such as glass or other transparent material. The edge strips are disposed between the plate 110 and the plate 120, and connected to the edge of the plate 110 and the plate 120, so as to form an airtight chamber 170 between the plate 110 and the plate 120.

Referring to both FIG. 1 and FIG. 2, the fluorescent substance 140 is disposed on the inner wall of the plate 110 and the plate 120. The discharge gas 150 is injected into a chamber 170, and the discharge gas is an inert gas such as Xe, Ne, and Ar. The electrode is disposed inside the chamber 170, and also corresponds to both sides of the plate 110 and the plate 120. The electrode 160 is electrically coupled to a power supply (not shown). The electrode is such as a silver electrode or a copper electrode.

During the lighting process of the cold cathode fluorescent flat lamp 100, the electrons mainly driven by and injected from the electrode 160 collide with the discharge gas 150 in the chamber 170, and the discharge gas 150 is ionized and excited to form a plasma. Then, the excited atoms in the plasma return to the steady state by emitting in ultraviolet, and the ultraviolet emissions further excite the fluorescent substance 140 on the inner walls of the plate 110 and the plate 120, so as to generate the visible light.

Although the conventional cold cathode fluorescent flat lamp is able to provide an even distributed plane light source, when it is used to provide a big size plane light source, the edge strip is the only component used to maintain the gap between the plates, and so the structure of its central area is rather weak and is easily damaged by improper forces from outside. Therefore, it is common to increase the thickness of the plates, but although such method is able to enhance the overall structure strength, since the increase of thickness results in the transparency degradation of the cold cathode fluorescent flat lamp, the brightness of the cold cathode fluorescent flat lamp is also deteriorated.

Besides increasing the thickness of the plates, several spacers can be inserted in between two plates in the conventional cold cathode fluorescent flat lamp, so as to enforce the structure strength of its central area and have the cold cathode fluorescent flat lamp sustain the atmosphere or even other improper forces from outside. However, such method complicates the manufacture of the cold cathode fluorescent flat lamp and also increases the manufacturing cost.

### SUMMARY OF THE INVENTION

Therefore, it is an object of the present invention to provide a cold cathode fluorescent flat lamp. The cold cathode fluorescent flat lamp is able to provide an even distributed plane light source, and is able to effectively enhance the overall structure strength of the cold cathode fluorescent flat lamp, so as to prevent the cold cathode fluorescent flat lamp from damage by improper forces from outside.

The cold cathode fluorescent flat lamp provided by the present invention mainly comprises a first plate, a second plate, a fluorescent substance, a discharge gas, and a plurality of electrodes, wherein the first plate has a plurality of grooves formed on it. The second plate is disposed on the first plate, so that the grooves constitute a plurality of airtight chambers. The fluorescent substance is disposed on part or all of the inner walls of the airtight chambers. The discharge gas is disposed inside the airtight chambers. The electrodes are disposed on both sides of the airtight chambers, respectively.

The present invention further provides a cold cathode fluorescent flat lamp. The cold cathode fluorescent flat lamp mainly comprises a first plate, a second plate, a fluorescent substance, a discharge gas, and a plurality of electrodes, wherein the first plate has a plurality of grooves formed on it, and the second plate also has a plurality of grooves formed on it. The second plate is disposed on the first plate, and the second grooves correspond to the first grooves, respectively, so that the first grooves and the second grooves constitute a plurality of airtight chambers. The fluorescent substance is disposed on part or all of the inner walls of the airtight chambers. The discharge gas is disposed inside the airtight chambers. The electrodes are disposed on both sides of the airtight chambers, respectively.

The present invention further provides a cold cathode fluorescent flat lamp. The cold cathode fluorescent flat lamp mainly comprises a wave-type structure, a first plate, a second plate, a fluorescent substance, a discharge gas, and a plurality of electrodes, wherein the wave-type structure has a plurality of wave peaks and wave troughs. The first plate is disposed on the wave troughs, so that a plurality of first airtight chambers is formed between the wave-type structure and the first plate. The second plate is disposed on the wave peaks, so that a plurality of second airtight chambers is formed between the wave-type structure and the second plate. The fluorescent substance is disposed on part or all of the inner walls of the first airtight chambers and the second airtight chambers. The discharge gas is disposed inside the first airtight chambers and the second airtight chambers. The electrodes are disposed on both sides of the first airtight chambers and the second airtight chambers.

In a preferred embodiment of the present invention, the first plate, the second plate, and the wave-type structure mentioned above are made of a material such as glass. The discharge gas is such as an inert gas (e.g. Xe, Ne, or Ar). The electrode is, such as a metal electrode (e.g. nickel electrode, silver electrode, copper electrode, molybdenum electrode, or niobium electrode). Further, an impedance device also can be disposed on the electrode, wherein the impedance device is such as a resistor, a capacitor, or an inductor.

In the preferred embodiment of the present invention, the first grooves and the second grooves mentioned above are such as the rectangle or arc grooves, and the first grooves and the second grooves are extended in parallel to one edge of the first plate, or the first grooves and the second grooves are extended in a direction inclined with a certain angle from one edge of the first plate.

Further, one or more connection grooves can be disposed in between the first grooves, so that each of the first grooves is connected with each other. Similarly, one or more connection grooves can be disposed in between the second grooves, so that each of the second grooves is connected with each other. Furthermore, if the cold cathode fluorescent flat lamp belongs to a type binding the wave-type structure with two plates, one or more connection grooves also can be formed on the wave-type structure, so that the wave-type structure is connected with each airtight chamber between the first plate and the second plate. Here, the width of the connection grooves mentioned above is for example 0.1 mm˜10 mm, and its depth is for example 0.1 mm˜5 mm.

By forming the connection grooves, when the cold cathode fluorescent flat lamp is performing the vacuuming step, all air inside the cold cathode fluorescent flat lamp can be vacuumed out completely in one time, and the discharge air also can be injected into the cold cathode fluorescent flat lamp in one time, so that the manufacturing process is simplified.

In the preferred embodiment of the present invention, the bottom of the first plate may be designed as a reflective surface, and the bottom of the second plate may be designed as a diffusion surface. By using the reflective surface and the diffusion surface mentioned above, the lighting efficiency of the cold cathode fluorescent flat lamp can be improved.

According to the present invention, several grooves are formed on the plates, so that the surface of the first plate can support the second plate. Optionally, a wave-type structure may be bound by the first plate and the second plate, so that the wave-type structure can support the first plate and the second plate. Therefore, the cold cathode fluorescent flat lamp is able to further reduce its thickness and enhance its structure strength, so as to prevent the cold cathode fluorescent flat lamp from damage by improper forces from outside. Furthermore, with the design of the grooves or wave-type structure mentioned above, the surface of the plates can be used as a supporting surface, thus the components, such as the edge strips and the spacers, are not needed to be disposed anymore. Therefore, it can reduce cost and simplify the manufacturing process.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a vertical view of a conventional cold cathode fluorescent flat lamp.

FIG. 2 schematically shows a sectional view seen from a cross-sectional line A-A in FIG. 1.

FIG. 3 schematically shows a vertical view of a cold cathode fluorescent flat lamp of a first preferred embodiment according to the present invention.

FIG. 4 schematically shows a sectional view seen from a cross-sectional line B-B in FIG. 3.

FIG. 5 schematically shows a sectional view of a cold cathode fluorescent flat lamp of a second preferred embodiment according to the present invention.

FIG. 6 schematically shows a vertical view of a cold cathode fluorescent flat lamp of a third preferred embodiment according to the present invention.

FIG. 7 schematically shows a vertical view of a cold cathode fluorescent flat lamp of a fourth preferred embodiment according to the present invention.

FIG. 8 schematically shows a sectional view seen from a cross-sectional line C-C in FIG. 7.

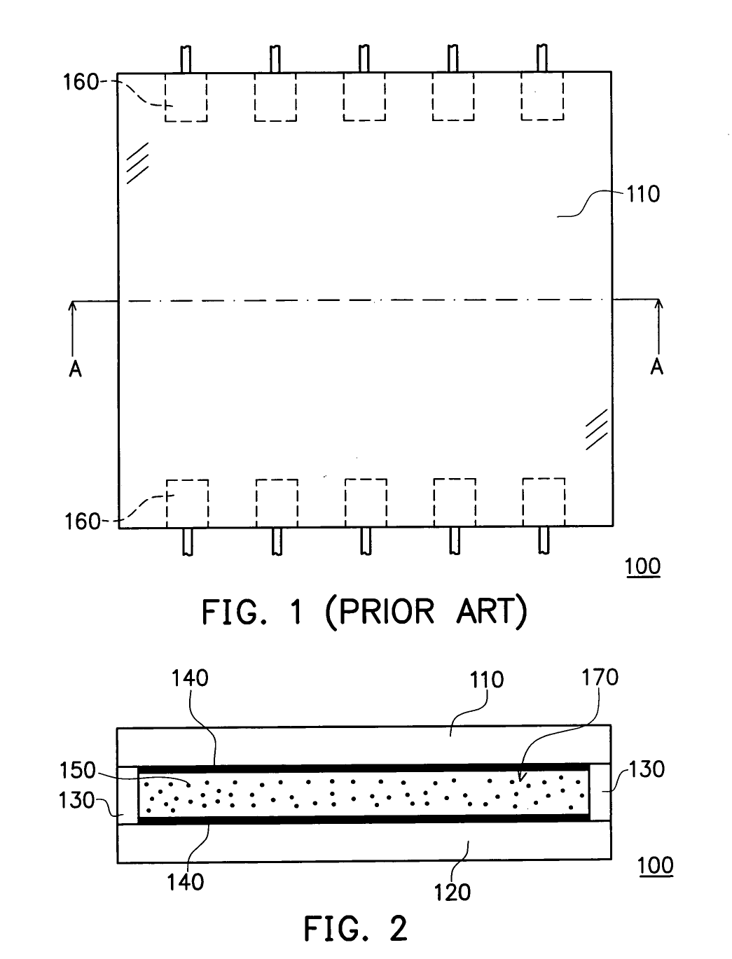

### DESCRIPTION OF THE PREFERRED EMBODIMENTS

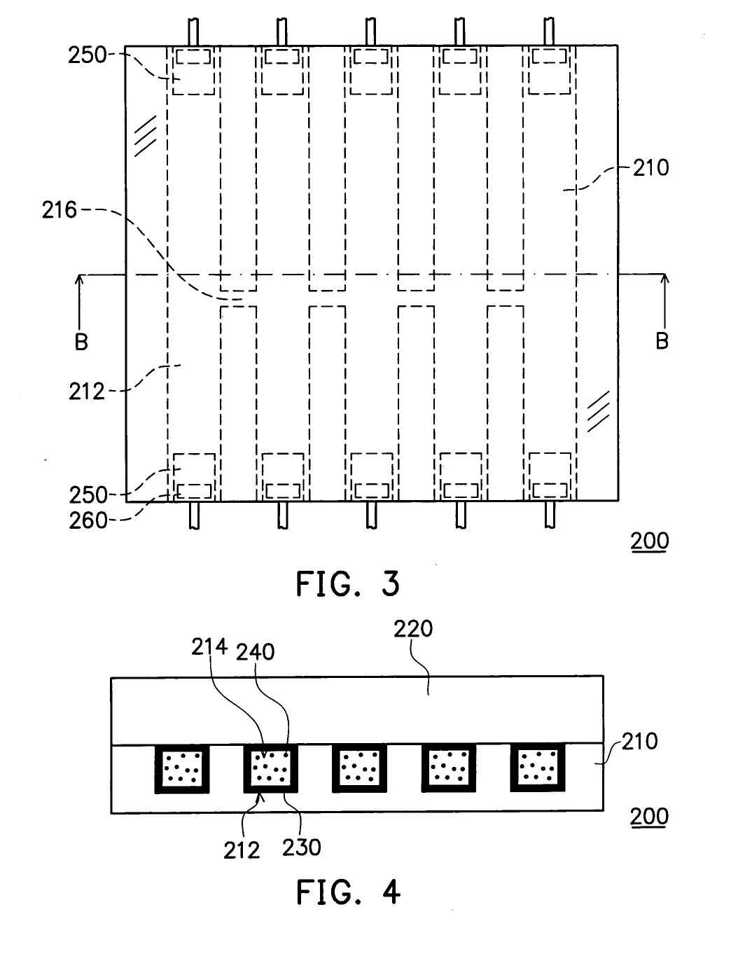

FIG. 3 schematically shows a vertical view of a cold cathode fluorescent flat lamp of a first preferred embodiment according to the present invention. FIG. 4 schematically shows a sectional view seen from a cross-sectional line B-B in FIG. 3. Referring to both FIG. 3 and FIG. 4, the cold cathode fluorescent flat lamp of the present embodiment 200 mainly comprises a first plate 210, a second plate 220, a fluorescent substance 230, a discharge gas 240, and a plurality of electrodes 250. Wherein, the first plate 210 has a plurality of rectangle type first grooves 212, and the second plate 220 is disposed on the first plate 210, so that the first grooves 212 can constitute a plurality of airtight chambers 214. The first plate 210 and the second plate 220 mentioned above are made of a material such as glass or other transparent material.

Referring to both FIG. 3 and FIG. 4, the fluorescent substance 230 is disposed on the inner walls of the airtight chambers 214, and it is disposed on all of the inner walls of the airtight chambers 214 (as shown in the drawing), or optionally disposed on part of the inner walls of the airtight chambers 214 (not shown). The discharge gas 240 is injected into the airtight chambers 214, and the discharge air 240 is an inert gas, such as Xe, Ne, or Ar. The electrodes 250 are disposed on both sides of the airtight chambers 214, respectively. The electrodes 250 are electrically coupled to a power supply (not shown), and the electrodes 250 are metal electrodes, such as the nickel electrode, silver electrode, cooper electrode, molybdenum electrode or niobium electrode.

Following the description above, during the lighting process of the cold cathode fluorescent flat lamp 200, the electrons mainly driven by and injected from the electrodes 250 collide with the discharge gas 240 in the airtight chambers 214, and the discharge gas 240 is ionized and excited to form a plasma. Then, the excited atoms in the plasma return to the steady state by emitting in ultraviolet, and the emitted ultraviolet emissions further excite the fluorescent substance 230 on the inner walls of the airtight chambers 214, so as to generate the visible light.

Further, since the first plate 210 and the second plate 220 are made of material such as glass or other transparent material, the visible light generated in each of the first grooves 212 is propagated through the first plate 210 and the second plate 220. The visible light also penetrates through the first plate 210 and the second plate 220, so as to emit an even distributed plane light source. Tthe first grooves 212 are extended in parallel to one edge of the first plate 210, or the first grooves 212 are extended in a direction inclined with a certain angle from one edge of the first plate 210.

The shape of the first grooves 212 mentioned above is not necessarily limited to a certain type, and can be a straight groove, a horizontal groove, or an oblique groove. An impedance device 260 can be further disposed on the electrodes 250 mentioned above, wherein the impedance device 260 is such as a resistor, a capacitor, or an inductor, for adjusting the impedance of the electrode 250.

To be noted, since a plurality of first grooves 212 is formed on the first plate 210, the surface of the first plate 210 is used as the supporting surface by the second plate 220, which is disposed on the first plate 210 to enhance the structure strength of the central area of the cold cathode fluorescent flat lamp, so as to prevent the cold cathode fluorescent flat lamp from damage by improper forces from outside. Therefore, it is not necessary to increase the thickness of the plates or dispose additional spacers anymore, thus the cost can be reduced.

Further, by having a certain design the mold can form the first grooves 212 together with the plates when the plates are being manufactured, and the discharge gas 240 can be injected into the internal space of the first grooves 212. Therefore, the edge strips are not needed for constituting the discharge gas chambers between two plates, so that the manufacturing process is simplified.

As shown in FIG. 3, one or more connection grooves 216 (only one is shown in the drawing) may be formed in between the first grooves 212, so that the first grooves 212 are connected with each other, and the width of the connection groove 216 is for example 0.1 mm˜10 mm, and its depth is for example 0.1 mm˜5 mm. Further, the connection grooves 216 are not limited to being formed in the central area of the cold cathode fluorescent flat lamp 200 as shown in FIG. 3. In other words, the connection grooves 216 can be formed on any appropriate location between the first grooves 212. With the design of the connection grooves 216, when the cold cathode fluorescent flat lamp 200 is performing the vacuuming step, all air inside the cold cathode fluorescent flat lamp 200 can be vacuumed out completely in one time, and the discharge air 240 also can be injected into the cold cathode fluorescent flat lamp 200 in one time, so that the manufacturing process is simplified.

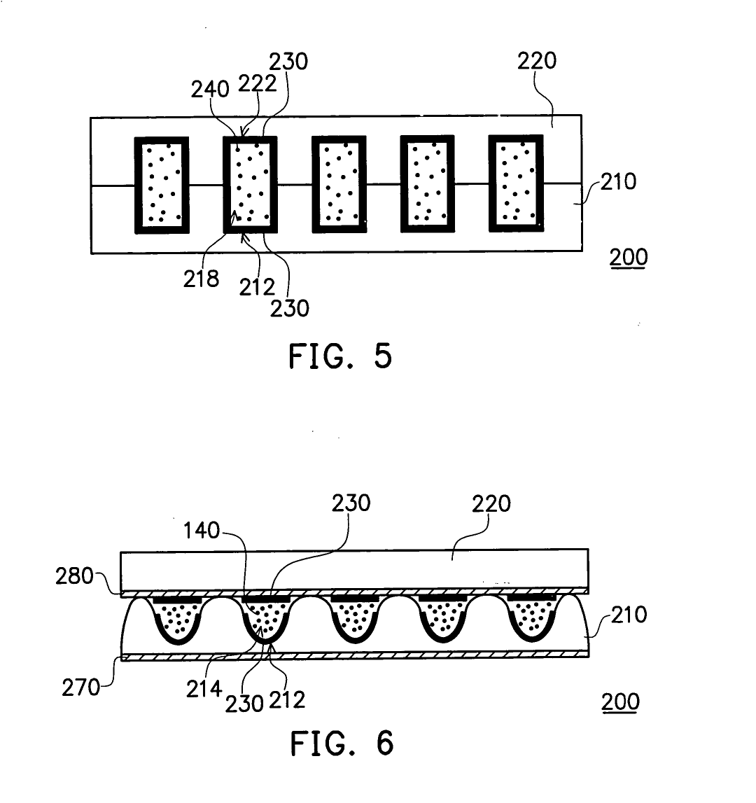

FIG. 5 schematically shows a sectional view of a cold cathode fluorescent flat lamp of a second preferred embodiment according to the present invention. Referring to FIG. 5, the structure of the cold cathode fluorescent flat lamp of the present embodiment is roughly the same as the structure in the first preferred embodiment, thus the same components are not described herein again. The difference is that a plurality of the rectangle type of the second grooves 222 is formed on the second plate 220, and the second grooves 222 corresponding to the first grooves 212 are formed on the first plate 210, so as to constitute a plurality of airtight chambers 218. The fluorescent substance 230 is disposed on all of the inner walls of the airtight chambers 218, but of course it can be optionally disposed on part of the inner walls of the airtight chambers 218. The discharge gas 240 is injected into the airtight chambers 218 mentioned above.

To be noted, since the corresponding first grooves 212 and the second grooves 222 are disposed on the first plate 210 and the second plate 220, the overall thickness of the cold cathode fluorescent flat lamp can be further reduced under the condition of the same airtight space.

FIG. 6 schematically shows a vertical view of a cold cathode fluorescent flat lamp of a third preferred embodiment according to the present invention. The structure of the cold cathode fluorescent flat lamp of the present embodiment is roughly the same as the structure in the first preferred embodiment, thus the same components are not described herein again. The difference is that the type of the first grooves 212 formed on the first plate 210 is changed from rectangle to arc, and the touch surface on the first plate 210 is changed from the original plane-touch style to the arc-touch style, so that the first plate 210 is formed as roughly a wave shape. By designing the touch surface on the first plate 210 mentioned above as an arc shape, the first plate 210 has the same effect as a lens, and the visible light generated by exciting the fluorescent substance 230 can be guided into the direction facing to the second plate 220.

Further, the bottom of the first plate 210 can be further designed as a reflective surface 270, for example, coating a layer of reflective material on it. The bottom of the second plate 220 can be further designed as a diffusion surface 280, such as a surface having a plurality of V-cuts or a plurality of concavities. With the design of the reflective surface 270 and the diffusion surface 280 mentioned above, the lighting efficiency of the cold cathode fluorescent flat lamp 200 can be further enhanced.

Following the descriptions above, since the width of the touch surface on the first plate 210 is narrowed down as an arc shape, the volume of the airtight chambers 214 can be further increased, and the efficiency of the steps of vacuuming or injecting the discharge gas mentioned above is further enhanced.

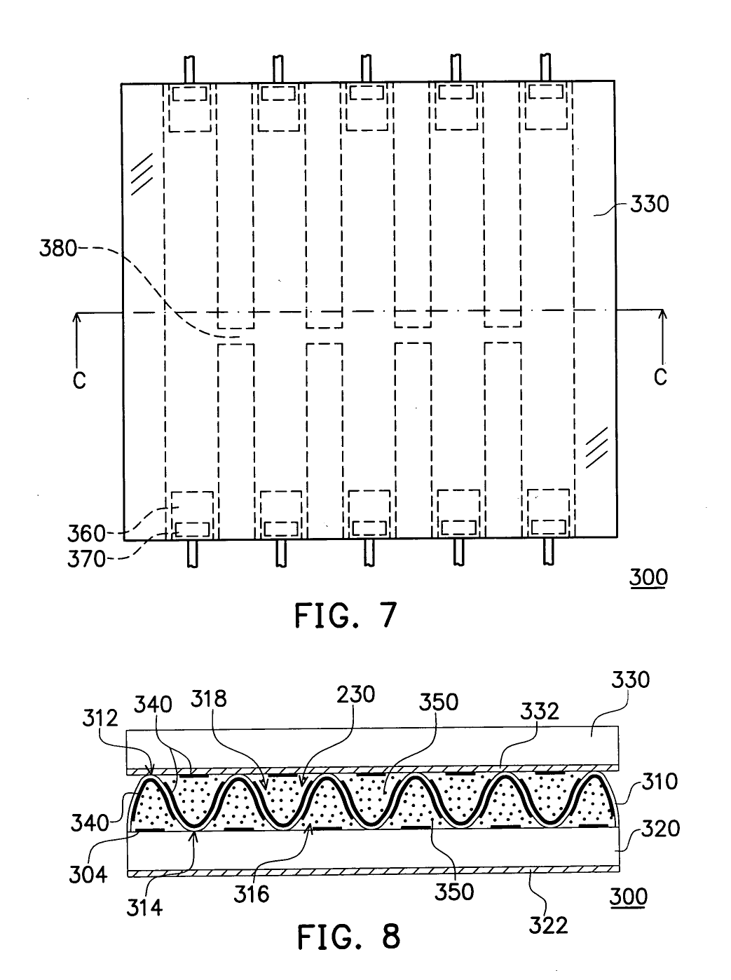

FIG. 7 schematically shows a vertical view of a cold cathode fluorescent flat lamp of a fourth preferred embodiment according to the present invention. FIG. 8 schematically shows a sectional view seen from a cross-sectional line C-C in FIG. 7. Referring to both FIG. 7 and FIG. 8, the cold cathode fluorescent flat lamp 300 of the present embodiment mainly comprises a wave-type structure 310, a first plate 320, a second plate 330, a fluorescent substance 340, a discharge gas 350, and a plurality of electrodes 360, wherein the wave-type structure 310 has a plurality of wave peaks 312 and wave troughs 314. The first plate 320 is disposed on the wave troughs 314, so that a plurality of first airtight chambers 316 is formed between the wave-type structure 310 and the first plate 320. The second plate 330 is disposed on the wave peaks 312, so that a plurality of second airtight chambers 318 is formed between the wave-type structure 310 and the second plate 330.

The fluorescent substance 340 is disposed on part or all of the inner walls of the first airtight chambers 316 and the second airtight chambers 318. The discharge gas 350, such as the inert gas like Xe, Ne, or Ar, is injected into the first airtight chambers 316 and the second airtight chambers 318. The electrodes 360, such as the metal electrodes like the nickel electrode, silver electrode, copper electrode, molybdenum electrode, or niobium electrode, are disposed on both sides of the first airtight chambers 316 and the second airtight chambers 318, respectively. The electrodes 360 are also electrically coupled to a power supply (not shown). Certainly, an impedance device 370, such as a resistor, a capacitor, or an inductor, also can be disposed on the electrodes 360 for adjusting the impedance of the electrodes 360.

Following the description above, the lighting process of the cold cathode fluorescent flat lamp 300 is the same as the lighting process in the embodiments mentioned above. The electrons mainly driven by and injected from the electrode 360 collide with the discharge gas 350 in the first airtight chambers 316 and the second airtight chambers 318, and the discharge gas 350 is ionized and excited to form a plasma. Then, the excited atoms in the plasma return to the steady state byof emitting in ultraviolet, and the emitted ultraviolet further excites the fluorescent substance 340 on the inner walls of the first airtight chambers 316 and the second airtight chambers 318, so as to generate visible light.

Further, similar to the embodiments mentioned above, one or more connection grooves 380 also can be formed on the wave-type structure 310, so that the wave-type structure 310 is connected to each of the airtight chambers between the first plate 320 and the second plate 330. Furthermore, similar to the embodiments mentioned above, the bottom of the first plate 320 may be designed as a reflective surface 322, and the bottom of the second plate 330 may be designed as a diffusion surface 332. With the design of the reflective surface 322 and the diffusion surface 332 mentioned above, the lighting efficiency of the cold cathode fluorescent flat lamp also can be improved.

Following descriptions above, a wave-type structure is bound by the first plate and the second plate in the present invention, so that the wave-type structure can support the first plate and the second plate, to achieve the object of enhancing the structure strength of the cold cathode fluorescent flat lamp.

In summary, the cold cathode fluorescent flat lamp of the present invention at least has following advantages:

1. By using the grooves designed on the plates or the wave-type structure bound by two plates, the surfaces of the plates are sustained, and the structure strength of the central area in the cold cathode fluorescent flat lamp can be enhanced, so as to prevent the cold cathode fluorescent flat lamp from damage by improper forces from outside.

2. By using the grooves designed on the plates or the wave-type structure bound by two plates, the surfaces of the plates are sustained. Therefore, the additional components, such as the edge strips and the spacers, are not needed anymore, so that cost can be reduced.

3. By using the connection grooves formed between the grooves on the plates or formed on the wave-type structure, when the cold cathode fluorescent flat lamp is performing the vacuuming step, all air inside the cold cathode fluorescent flat lamp can be vacuumed out completely in one time, and the discharge air also can be injected into the cold cathode fluorescent flat lamp in one time, so that the manufacturing process is simplified and the manufacturing time is effectively reduced.

4. By reducing the touch surface distance of the plates, the volume of the airtight chambers is increased, and the efficiency of the steps of vacuuming and injecting discharge air is also further improved.

5. By forming a reflective surface on the bottom of the top plate and forming a diffusion surface on the bottom of the bottom plate, the lighting efficiency of the cold cathode fluorescent flat lamp is improved.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A cold cathode fluorescent flat lamp, comprising:
a first plate, having a plurality of grooves;
a second plate, disposed on the first plate, so that the grooves constitute a plurality of airtight chambers;
a fluorescent substance, disposed on either part of or all of the inner walls of the airtight chambers;
a discharge gas, disposed inside the airtight chambers; and
a plurality of electrodes, disposed on both sides of the airtight chambers, respectively.

2. The cold cathode fluorescent flat lamp of claim 1, wherein the first plate and the second plate are made of a material such as glass.

3. The cold cathode fluorescent flat lamp of claim 1, wherein the discharge gas comprises an inert gas.

4. The cold cathode fluorescent flat lamp of claim 3, wherein the inert gas comprises Xe, Ne, or Ar.

5. The cold cathode fluorescent flat lamp of claim 1, wherein the electrodes are made of a metal electrode.

6. The cold cathode fluorescent flat lamp of claim 5, wherein the metal electrode comprises nickel electrode, silver electrode, copper electrode, molybdenum electrode, or niobium electrode.

7. The cold cathode fluorescent flat lamp of claim 1, wherein the grooves are extended in parallel to one edge of the first plate.

8. The cold cathode fluorescent flat lamp of claim 1, wherein the grooves are extended in a direction inclined with a certain angle from one edge of the first plate.

9. The cold cathode fluorescent flat lamp of claim 1, wherein the grooves comprise either rectangle grooves or arc grooves.

10. The cold cathode fluorescent flat lamp of claim 1, further comprising at least one connection groove, wherein the connection groove is formed in between the grooves, so that the grooves are connected with each other.

11. The cold cathode fluorescent flat lamp of claim 10, wherein the width of the connection groove is 0.1 mm˜10 mm, and the depth of the connection groove is 0.1 mm˜5 mm.

12. The cold cathode fluorescent flat lamp of claim 1, wherein the bottom of the first plate is a reflective surface.

13. The cold cathode fluorescent flat lamp of claim 1, wherein the bottom of the second plate is a diffusion surface.

14. The cold cathode fluorescent flat lamp of claim 1, further comprising an impedance device, wherein the resistance device is disposed on the electrodes, and the impedance device is a resistor, a capacitor, or an inductor.

15. A cold cathode fluorescent flat lamp, comprising:
a first plate, having a plurality of first grooves;
a second plate, having a plurality of second grooves, wherein the second plate is disposed on the first plate, and the second grooves are corresponded to the first grooves, respectively, so that the first grooves and the second grooves constitute a plurality of airtight chambers;
a fluorescent substance, disposed on either part of or all of the inner walls of the airtight chambers;
a discharge gas, disposed inside the airtight chambers; and
a plurality of electrodes, disposed on both sides of the airtight chambers, respectively.

16. The cold cathode fluorescent flat lamp of claim 15, wherein the first plate and the second plate are made of a material such as glass.

17. The cold cathode fluorescent flat lamp of claim 15, wherein the discharge gas comprises an inert gas.

18. The cold cathode fluorescent flat lamp of claim 17, wherein the inert gas comprises Xe, Ne, or Ar.

19. The cold cathode fluorescent flat lamp of claim 15, wherein the electrodes are made of a metal electrode.

20. The cold cathode fluorescent flat lamp of claim 19, wherein the metal electrode comprises nickel electrode, silver electrode, copper electrode, molybdenum electrode, or niobium electrode.

21. The cold cathode fluorescent flat lamp of claim 15, wherein the first grooves and the second grooves are extended in parallel to one edge of the first plate.

22. The cold cathode fluorescent flat lamp of claim 15, wherein the first grooves and the second grooves are extended in a direction inclined with a certain angle from one edge of the first plate.

23. The cold cathode fluorescent flat lamp of claim 15, further comprising at least one connection groove, wherein the connection groove is formed in between the first grooves, so that the first grooves are connected with each other.

24. The cold cathode fluorescent flat lamp of claim 15, wherein the first grooves and the second grooves comprise either rectangle grooves or arc grooves.

25. The cold cathode fluorescent flat lamp of claim 15, further comprising at least one connection groove, wherein the connection groove is formed in between the second grooves, so that the second grooves are connected with each other.

26. The cold cathode fluorescent flat lamp of claim 25, wherein the width of the connection groove is 0.1 mm˜10 mm, and the depth of the connection groove is 0.1 mm˜5 mm.

27. The cold cathode fluorescent flat lamp of claim 15, wherein the bottom of the first plate is a reflective surface.

28. The cold cathode fluorescent flat lamp of claim 15, wherein the bottom of the second plate is a diffusion surface.

29. The cold cathode fluorescent flat lamp of claim 15, further comprising an impedance device, wherein the resistance device is disposed on the electrodes, and the impedance device is a resistor, a capacitor, or an inductor.

30. A cold cathode fluorescent flat lamp, comprising:
a wave-type structure, having a plurality of wave peaks and a plurality of wave troughs;
a first plate, disposed on the wave troughs, so that a plurality of first airtight chambers are formed between the wave-type structure and the first plate;
a second plate, disposed on the wave peaks, so that a plurality of second airtight chambers are formed between the wave-type structure and the second plate;
a fluorescent substance, disposed on either part of or all of the inner walls of the first airtight chambers and the second airtight chambers;
a discharge gas, disposed inside the first airtight chambers and the second airtight chambers; and
a plurality of electrodes, disposed on both sides of the first airtight chambers and the second airtight chambers, respectively.

31. The cold cathode fluorescent flat lamp of claim 30, wherein the first plate and the second plate are made of a material such as glass.

32. The cold cathode fluorescent flat lamp of claim 30, wherein the discharge gas comprises an inert gas.

33. The cold cathode fluorescent flat lamp of claim 32, wherein the inert gas comprises Xe, Ne, or Ar.

34. The cold cathode fluorescent flat lamp of claim 30, wherein the electrodes are made of a metal electrode.

35. The cold cathode fluorescent flat lamp of claim 34, wherein the metal electrode comprises nickel electrode, silver electrode, copper electrode, molybdenum electrode, or niobium electrode.

36. The cold cathode fluorescent flat lamp of claim 30, further comprising at least one connection groove, wherein the connection groove is formed on the wave-type structure, so that the first airtight chambers and the second airtight chambers are connected with each other.

37. The cold cathode fluorescent flat lamp of claim 36, wherein the width of the connection groove is 0.1 mm˜10 mm, and the depth of the connection groove is 0.1 mm˜5 mm.

38. The cold cathode fluorescent flat lamp of claim 30, wherein the bottom of the first plate is a reflective surface.

39. The cold cathode fluorescent flat lamp of claim 30, wherein the bottom of the second plate is a diffusion surface.

40. The cold cathode fluorescent flat lamp of claim 30, further comprising an impedance device, wherein the impedance device is disposed on the electrodes, and the impedance device is a resistor, a capacitor, or an inductor.
